(19) United States
(12) Patent Application Publication
(10) Pub. No.: US 2022/0414191 A1
(43) Pub. Date: Dec. 29, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventor: Satoru SAKUMA, Nagakute-shi (JP)

(73) Assignee: TOYOTA JIDOSHA KABUSHIKI KAISHA, Toyota-shi (JP)

(21) Appl. No.: 17/838,369

(22) Filed: Jun. 13, 2022

(30) Foreign Application Priority Data
Jun. 23, 2021 (JP) 2021-104206

(51) Int. Cl. G06F 21/31; G07C 5/08

(52) U.S. Cl. CPC G06F 21/31; G07C 5/0816

(57) ABSTRACT

An information processing apparatus disclosed provides a telematics service. The information processing apparatus has a controller. When contract of subscription to the telematics service is made, the controller sets an email address designated by a user as a login ID for the telematics service. Moreover, the controller stores the login ID thus set in a memory with its link with a vehicle of which the user has the ownership or the right to use.

### CROSS REFERENCE TO THE RELATED APPLICATION

This application claims the benefit of Japanese Patent Application No. 2021-104206, filed on Jun. 23, 2021, which is hereby incorporated by reference herein in its entirety.

### BACKGROUND

### Technical Field

The present disclosure relates to an information processing apparatus, an information processing method, and a non-transitory storage medium.

### DESCRIPTION OF THE RELATED ART

It is known in the art in recent times to provide telematics services through tablet terminals that occupants of vehicles can carry (see, for example, Patent Literature 1 in the following citation list).

### CITATION LIST

### Patent Literature

Patent Literature 1: Japanese Patent Application Laid-Open No. 2017-226399

### SUMMARY

An object of this disclosure is to provide a technology that can promote use of telematics services by users.

Disclosed herein is an information processing apparatus. The information processing apparatus may comprise, for example, a controller including at least one processor configured to execute the processing of:

setting a first character string determined by a first user as a login ID for a telematics service; and

storing the login ID in a memory with its link with a first vehicle.

Also disclosed herein is an information processing method. The information processing method may comprise, for example, the following steps of processing executed by a computer:

setting a first character string determined by a first user as a login ID for a telematics service; and

storing the login ID in a memory with its link with a first vehicle.

Also disclosed herein is an information processing program configured to cause a computer to implement the above-described information processing method and a non-transitory storage medium in which this information processing program is stored.

According to this disclosure, there is provided a technology that can promote use of telematics services by users.

### BRIEF DESCRIPTION OF THE DRAWINGS

FIG. 1 is a diagram illustrating the general configuration of a telematics system.

FIG. 2 is a block diagram illustrating exemplary hardware configurations of a telematics terminal, a server apparatus, and a user's terminal included in the telematics system.

FIG. 3 is a block diagram illustrating an exemplary functional configuration of the server apparatus according to an embodiment.

FIG. 4 illustrates an exemplary structure of a subscription information table according to an embodiment.

FIG. 5 illustrates another exemplary structure of the subscription information table according to the embodiment.

FIG. 6 illustrates an example of a screen for setting a login ID according to the embodiment.

FIG. 7 is a flow chart of a processing routine executed by the server apparatus when contract of subscription to a telematics service is made.

FIG. 8 is a flow chart of a processing routine executed by the server apparatus when an authentication request is received.

FIG. 9 illustrates an example of a screen for setting a login ID according to a first modification.

### DESCRIPTION OF THE EMBODIMENTS

An information processing apparatus disclosed herein is applied to a system that provides a telematics service, which will also be referred to as “telematics system” hereinafter. The telematics service provided may include, for example, searching for information, updating map data of a car navigation system, setting a destination on a car navigation system, emergency warning, providing vehicle maintenance information, providing voice communication with an operator, providing connection to the Internet, remote-controlling a vehicle, setting security of a vehicle, finding the location of a vehicle, making settings relating to contract of subscription (or sign-up) to the telematics service, and purchasing optional items.

The services such as searching for information, updating map data of a car navigation system, setting a destination on a car navigation system, emergency warning, providing vehicle maintenance information, providing voice communication with an operator, providing connection to the Internet, making settings relating to contract of subscription to the telematics service, and purchasing optional items are provided to an occupant of a vehicle through a telematics terminal provided in the vehicle.

The services such as providing vehicle maintenance information, remote-controlling a vehicle, setting security of a vehicle, finding the location of a vehicle, making settings relating to contract of subscription to the telematics service, and purchasing optional items are provided to a user through a terminal used by the user.

When a telematics service is used, it is necessary for the information processing apparatus to identify a vehicle to which the service is to be provided. Hence, when a first user uses the telematics service, it is necessary for the first user to log in to the telematics service with a vehicle ID assigned to the first vehicle for which the telematics service is to be provided (or the telematics terminal provided in the first vehicle). However, such a vehicle ID can be a character string difficult for the user to memorize in some cases, because it is determined randomly by the TSP when contract of subscription to the telematics service is made. Bothering the first user in memorizing the vehicle ID can discourage him/her from using the telematics service.

The information processing apparatus disclosed herein has a controller configured to set a first character string determined by the first user as the login ID for the telematics service. The controller stores the login ID thus set in a memory with its link with the first vehicle. Consequently, when login to the telematics service is made with the first character string, the information processing apparatus can identify the first vehicle for which the telematics service is to be provided by accessing the memory using the first character string as an argument. Thus, the first user can log in to the telematics service with the first character string to use the telematics service relating to the first vehicle. The first character string set as the login ID may be determined arbitrarily by the first user. Therefore, the first user can set a character string easy for him/her to memorize as the login ID. This eliminates the need for the first user to memorize the vehicle ID constituted by a character string that is unfamiliar to him/her. This can encourage the first user to use the telematics service.

The first character string may be an email address or a telephone number relating to the first user. This allows the first user to use a character string familiar to him/her as the login ID for the telematics service.

In cases where the first user owns or has the right to use a plurality of first vehicles, the controller may link the aforementioned login ID with the plurality of first vehicles. This eliminates the need for the user to memorize different vehicle IDs associated with the respective first vehicles.

In the process of setting a login ID, the controller may further execute the processing of causing a first terminal used by the first user to display a screen prompting the first user to enter the first character string and the vehicle ID of the first vehicle, and receiving the first character string and the vehicle ID entered into the first terminal from the first terminal. In this case, the control unit may set the first character string received from the first terminal as the login ID for the telematics service and link the login ID thus set with the first vehicle associated with the vehicle ID. In this way, the first user can set the login ID for the telematics service through the first terminal. The vehicle ID mentioned here is information that identifies the vehicle for which the telematics service is to be provided. The vehicle ID is determined randomly by the provider of the telematics service at the time when contract of subscription to the telematics service is made.

If the aforementioned login ID is not set, the controller may cause the telematics terminal to display a screen that prompts setting of the login ID at a specific time. This can prompt the first user to set the aforementioned login ID. The specific time may be, for example, the time when the first vehicle is started or the time when an operation relating to the telematics service is conducted on the telematics terminal.

In the case where the aforementioned login ID is not set, the controller may execute the processing of receiving the vehicle ID of the first vehicle from the telematics terminal, performing authentication based on the vehicle ID received from the telematics terminal, and, if the authentication succeeds, allowing login to the telematics service. In this case, even if the aforementioned login ID has not been set, the first user can log in to the telematics service with the vehicle ID.

The present disclosure may be construed to describe an information processing method performed by a computer by executing the above-described processing, an information processing program that causes a computer to execute this information processing method, or a non-transitory storage medium that stores such a processing program. In this connection, the computer constitutes the above-described information processing apparatus. The computer may be, for example, a server apparatus under the control of the provider of the telematics service.

### Embodiment

In the following, an embodiment of the technology disclosed herein will be described with reference to the drawings. It should be understood that the following description of the embodiment will be given by way of illustration, and the technology disclosed herein is not limited to the illustrative configuration of the embodiment.

### General Configuration of System

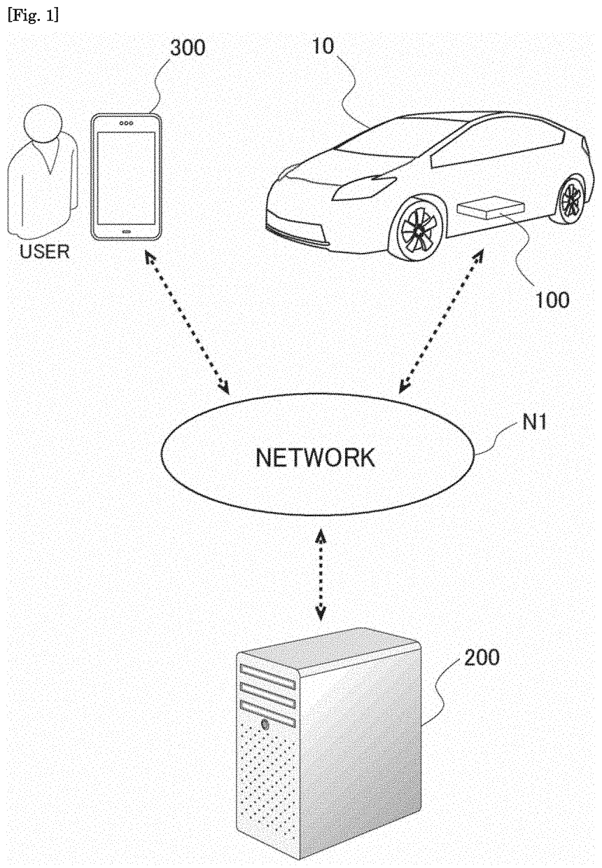

FIG. 1 is a diagram illustrating the generation configuration of a telematics system to which the technology disclosed herein is applied. The telematics system according to the embodiment includes a telematics terminal 100 provided in a vehicle 10, a server apparatus 200 (corresponding to the information processing apparatus according to the present disclosure) provided externally to the vehicle 10, and a user's terminal 300 (corresponding to the first terminal according to the present disclosure) used by a user (corresponding to the first user according to the present disclosure) who owns or has the right to use the vehicle 10. The telematics terminal 100, the server apparatus 200, and the user's terminal 300 communicate bidirectionally with each other through a network N1, which will be described later. While FIG. 1 shows only one vehicle 10, the telematics system may include a plurality of vehicles 10.

The telematics terminal 100 receives operations relating to telematics services and executes the processing for providing the services associated with the operations it has received to an occupant of the vehicle 10. For example, when an operation for using a telematics service is conducted, the telematics terminal 100 displays a screen that prompts the user to enter a login ID (e.g. a login screen). The login ID is a character string determined arbitrary by the user, which corresponds to the first character string according to the present disclosure. An email address of the user is used as the login ID in this illustrative embodiment. The login ID is not limited to an email address, but any character string that is easy for the user to memorize may be used as the login ID. For example, the login ID may be a telephone number of the user. If the login operation with the login ID is conducted by the occupant of the vehicle 10, the telematics terminal 100 sends an authentication request containing the login ID to the server apparatus 200. If the authentication succeeds in the server apparatus 200 that has received the authentication request, information indicating the success of authentication is sent from the server apparatus 200 to the telematics terminal 100. When the telematics terminal 100 receives the information indicating the success of authentication from the server apparatus 200, the telematics terminal 100 displays a menu screen of telematics services. The menu screen shows a list of telematics services available through the telematics terminal 100.

Examples of the telematics services available through the telematics terminal 100 include searching for information, updating map data of a car navigation system, setting a destination on the car navigation system, emergency warning, providing vehicle maintenance information, providing voice communication with an operator, providing connection to the Internet, making settings relating to contract of subscription to the telematics service, and purchasing optional items.

If the user selects a telematics service he or she wants on the aforementioned menu screen, the telematics terminal 100 accepts the use of the selected telematics service. Specifically, the telematics terminal 100 executes the processing for providing the selected telematics service to the user.

The user's terminal 300 is a computer used by the user who owns or has the right to use the vehicle 10. The user's terminal 300 receives operations relating to telematics services and executes the processing for providing the services associated with the operations it has received to the user. For example, when an operation for starting use of a telematics service is conducted, the user's terminal 300 displays a login screen. If the login operation with the login ID is conducted by the user, the user's terminal 300 sends an authentication request containing the login ID to the server apparatus 200. If the authentication succeeds in the server apparatus 200 that has received the authentication request, information indicating the success of authentication is sent from the server apparatus 200 to the user's terminal 300. When the user's terminal 300 receives the information indicating the success of authentication from the server apparatus 200, the user's terminal 300 displays a menu screen of telematics services. The menu screen shows a list of telematics services available through the user's terminal 300.

Examples of the telematics services available through the user's terminal 300 include remote-controlling the vehicle 10, providing information concerning maintenance of the vehicle 10, setting security of the vehicle 10, finding the location of the vehicle 10, making settings relating to contract of subscription to the telematics service, and purchasing optional items.

If the user selects a telematics service he or she wants on the aforementioned menu screen, the user's terminal 300 accepts the use of the selected telematics service. Specifically, the user's terminal 300 executes the processing for providing the selected telematics service to the user.

The server apparatus 200 is managed by a Telematics Service Provider (TSP). The server apparatus 20) has the functions of receiving the above-described requests relating to telematics services from the telematics terminal 100 or the user's terminal 300 and providing information responding to the requests it has received to the telematics terminal 100 or the user's terminal 300. For example, when the server apparatus 300 receives an authentication request from the telematics terminal 100 or the user's terminal 300, it performs authentication with the login ID and sends the result of the authentication to the telematics terminal 100 or the user's terminal 300. The server apparatus 200 according to the embodiment also has the function of linking the login ID and the vehicle ID (or the telematics terminal 100). For example, when contract of subscription to the telematics service is made between the user and the TSP, the server apparatus 200 causes the user's terminal 300 to display a screen that prompts the user to enter an email address. When the user enters an email address to the user's terminal 300, the entered email address is sent from the user's terminal 300 to the server apparatus 200. The server apparatus 200 sets the email address received from the user's terminal 300 as the login ID and links the login ID with the vehicle ID of the vehicle 10 to which the telematics service is to be provided. The vehicle ID is information for identifying the vehicle 10 to which the telematics service is to be provided. The vehicle ID is a character string that is determined randomly by the TSP when contract of subscription to the telematics service is made.

### Hardware Configuration of System

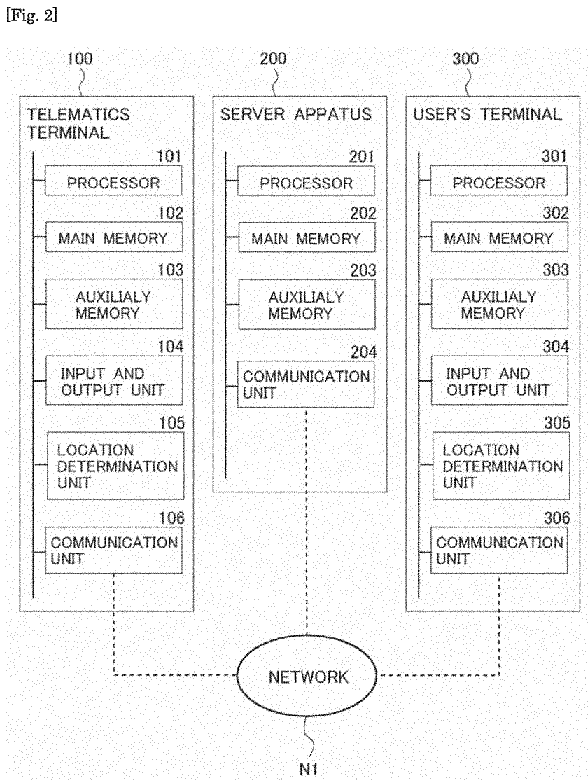

FIG. 2 is a diagram illustrating exemplary configurations of the telematics terminal 100, the server apparatus 200, and the user's terminal 300 included in the telematics system.

(Telematics Terminal)

The telematics terminal 100 is a small computer provided in the vehicle 10. As illustrated in FIG. 2, the telematics terminal 100 includes a processor 101, a main memory 102, an auxiliary memory 103, an input and output unit 104, a location determination unit 105, and a communication unit 106. These components are interconnected by buses. The main memory 102 and the auxiliary memory 103 are computer-readable recording media. The hardware configuration of the telematics terminal 100 is not limited to that illustrated in FIG. 2, but some components may be eliminated, replaced by other components, or added fitly.

The processor 101 is, for example, a CPU (Central Processing Unit) or a DSP (Digital Signal Processor). The processor 101 executes various information-processing computations to control the telematics terminal 100.

The main memory 102 includes, for example, a RAM (Random Access Memory) and a ROM (Read Only Memory). The auxiliary memory 103 includes, for example, an EPROM (Erasable Programmable ROM), or an HDD (Hard Disk Drive).

The auxiliary memory 103 may include a removable medium or a portable recording medium. Examples of the removable medium include a USB (Universal Serial Bus) memory, a CD (Compact Disc), or a DVD (Digital Versatile Disc). The auxiliary memory 103 stores various programs, various data, and various tables in a recording medium; these programs, data, and tables can be written into and read out from the recording medium when necessary. The programs stored in the auxiliary memory 103 include an operating system (OS) and application programs relating to the telematics service. All or a portion of the information stored in the auxiliary memory 103 may be stored in the main memory 102 instead.

The input and output unit 104 receives inputting operations conducted by the user and presents information to the user. The input and output unit 104 includes, for example, a touch panel, a control circuit for the touch panel, a liquid crystal display, a control circuit for the liquid crystal display, a microphone, a control circuit for the microphone, a speaker, and a control circuit for the speaker. The touch panel and the liquid crystal display may be constituted by a single touch panel display.

The location determination unit 105 is an apparatus that determines the present location of the telematics terminal 100 (i.e. the present location of the vehicle 10). The location determination unit 105 typically includes a GPS (Global Positioning System) receiver.

The communication unit 106 is a wireless communication interface for connecting the telematics terminal 100 to the network N1. The communication unit 106 is connected to the network N1 using a mobile communication service, such as 5G (5th Generation) mobile communications, or LTE (Long Term Evolution) mobile communications, or a wireless communication network, such as Wi-Fi (registered trademark) to communicate with server apparatus 200 through the network N1.

The network N1 may be, for example, a WAN (Wide Area Network), which may be a global public communication network such as the Internet, or other communication network. The network N1 may include a telephone communication network, such as a cellular phone network, or a wireless communication network, such as Wi-Fi (registered trademark).

The processor 101 of the telematics terminal 100 implements functions for achieving desired purposes by executing a program(s) stored in the auxiliary memory 103. For example, the processor 101 implements the functions of prompting the user to log in to the service with the login ID, sending an authentication request to the server apparatus 200, presenting telematics services available through the telematics terminal 100, and receiving the user's operation of selecting a telematics service that the user wants.

The above-described functions are implemented by a web browser running on the telematics terminal 100 or an application program(s) installed in the telematics terminal 100. Some or all of the functions implemented by the telematics terminal 100 may be implemented by a hardware circuit, such as an ASIC (Application Specific Integrated Circuit) or an FPGA (Field Programmable Gate Array).

(User's Terminal)

The user's terminal 300 is a personally-used computer, such as a personal computer, a smartphone, a cellular phone, a tablet computer, or a personal information terminal. As illustrated in FIG. 2, the user's terminal 300 includes a processor 301, a main memory 302, an auxiliary memory 303, an input and output unit 304, a location determination unit 305, and a communication unit 306. The processor 301, the main memory 302, the auxiliary memory 303, the input and output unit 304, the location determination unit 305, and the communication unit 306 are similar to the processor 101, the main memory 102, the auxiliary memory 103, the input and output unit 104, the location determination unit 105, and the communication unit 106 of the telematics terminal 100 and will not be described further.

The processor 301 of the user's terminal 300 implements functions for achieving desired purposes by executing a program(s) stored in the auxiliary memory 303. For example, the processor 301 implements the functions of prompting the user to log in to the service with the login ID, sending an authentication request to the server apparatus 200, presenting telematics services available through the user's terminal 300, and receiving the user's operation of selecting a telematics service that the user wants.

The processor 301 also implements the function of prompting the user to set the login ID when contract of subscription to the telematics service is made between the user and the TSP. Specifically, after contract of subscription to the telematics service is made between the user and the TSP through a web browser of the user's terminal, the processor 301 causes the touch panel display of the input and output unit 304 to display a screen that prompts the user to enter an email address. After an email address is entered by the user, the processor 301 sends the email address to the server apparatus 200.

The above-described functions are implemented by a web browser running on the user's terminal 300 or an application program(s) installed in the user's terminal 300. Some or all of the functions implemented by the user's terminal 300 may be implemented by a hardware circuit, such as an ASIC or an FPGA.

(Server Apparatus)

The server apparatus 200 is a computer provided externally to the vehicle 10. The server apparatus 200 in the system of this embodiment is provided in, for example, a business place of the TSP. As illustrated in FIG. 2, the server apparatus 200 includes a processor 201, a main memory 202, an auxiliary memory 203, and a communication unit 204. These components are interconnected by buses. The hardware configuration of the server apparatus 200 is not limited to that illustrated in FIG. 2, but some components may be eliminated, replaced by other components, or added fitly.

The processor 201, the main memory 202, and the auxiliary memory 203 are similar to the processor 101, the main memory 102, and the auxiliary memory 103 the telematics terminal 100. The programs stored in the auxiliary memory 203 include a program for linking login IDs and vehicle IDs and a program for performing authentication with login IDs.

The communication unit 204 is a communication interface that connects the server apparatus 200 to the network N1. The communication unit 204 may include, for example, a LAN (Local Area Network) interface board or a wireless communication circuit for wireless communication. The communication unit 204 is connected to the network N1 by a LAN or a wireless communication network to communicate with the telematics terminal 100 through the network N1.

### Functional Configuration of Server Apparatus

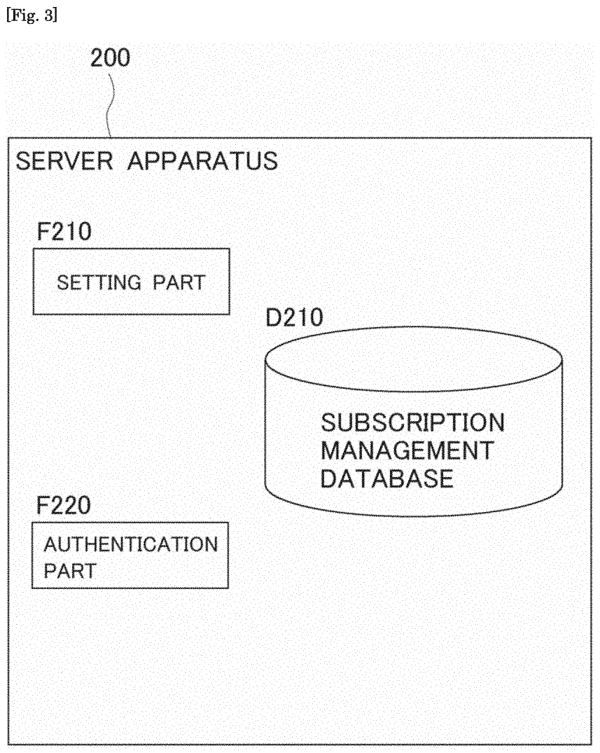

The functional configuration of the sever apparatus 200 will now be described with reference to FIG. 3. The server apparatus 200 of this embodiment is configured to constitute a web server that interacts with the user's terminal 300. The user can perform operations such as making contract of subscription to the telematics services and setting the login ID, by accessing the web server through the web browser of the user's terminal 300. The server apparatus 200 may provide similar services by other means than the web server. For example, the server apparatus 200 may execute the processing of interacting with the user's terminal 300 by an application program installed in the user's terminal 300 and a certain protocol.

As illustrated in FIG. 3, the server apparatus 200 configured to implement the above-described functions includes, as functional components, a setting part F210, an authentication part F220, and a subscription management database D210. The setting part F210 and the authentication part F220 are implemented by the processor 201 of the server apparatus 200 by executing programs stored in the auxiliary memory 203. The processor 201 implementing the above-described functional components corresponds to the controller according to the present disclosure. The setting part F210 and the authentication part F220 may be implemented partly or entirely by a hardware circuit, such as an ASIC or a FPGA. The subscription management database D210 is constructed in the auxiliary memory 203 by a database management system program (DBMS program) executed by the processor 201 of the server apparatus 200. The subscription management database D210 may be, for example, a relational database.

One or some of the functional components of the server apparatus 200 or a part of the processing thereof may be executed by another computer connected to the network N1. For example, the processing executed as the setting part F210 and the processing executed as the authentication part F220 may be executed by different computers.

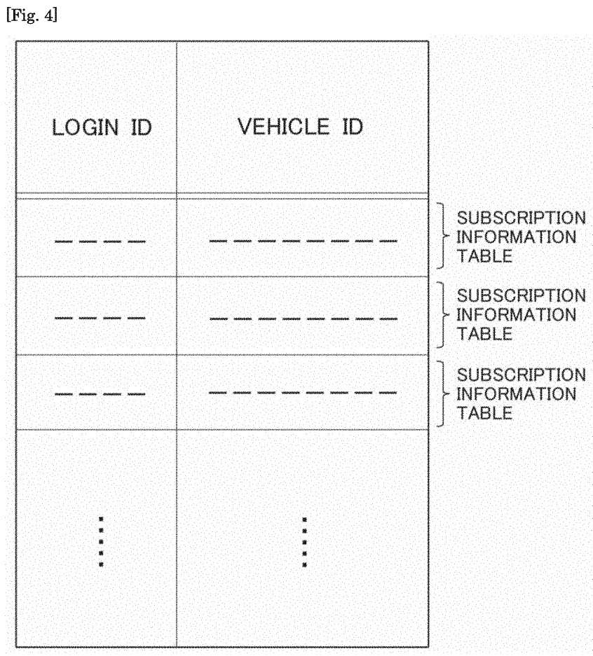

What is stored in the subscription management database D210 is information relating to the users who subscribe to the telematics service, where the login IDs and the respective vehicles 10 are linked with each other. An exemplary structure of information stored in the subscription management database D210 will be described here with reference to FIG. 4. FIG. 4 illustrates an exemplary table structure of information stored in the subscription management database D210. In the case illustrated in FIG. 4, a plurality of tables prepared for respective users are stored in the subscription management database D210. This table will also be referred to as “subscription information table” hereinafter.

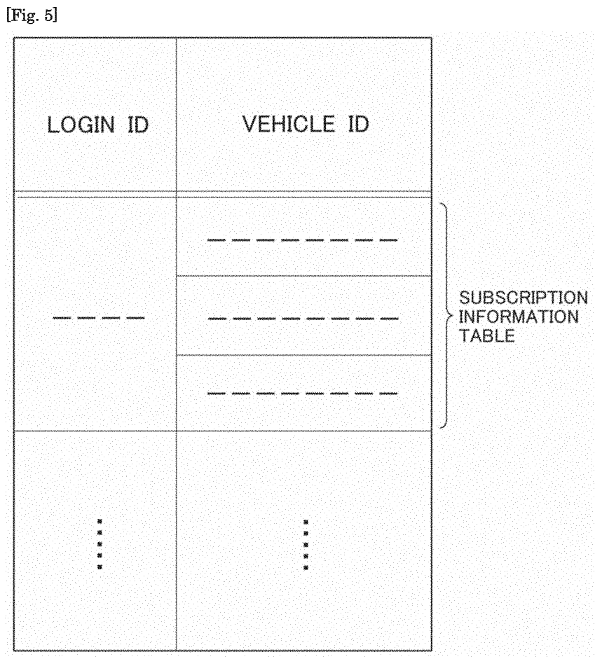

As illustrated in FIG. 4, the subscription information table has the fields of login ID and vehicle ID. What is stored in the login ID field is the email address of the user. What is stored in the vehicle ID field is the vehicle ID of the vehicle 10 of which the user has the ownership or the right to use. In cases where the user has the ownership or the right to use of a plurality of vehicles, the vehicle IDs of the plurality of vehicles are linked with one login ID, as illustrated in FIG. 5. The subscription management database D210 (or the auxiliary memory 203) in which the subscription information tables are stored corresponds to the memory according to this disclosure.

The subscription information table is created in the subscription management database D210 at the time when contract of subscription to the telematics service is made between the user and the TSP and deleted when the contract of subscription to the telematics service held between the user and the TSP is cancelled.

The structure of the subscription information table is not limited to that illustrated in FIG. 4, but one or some fields may be added, changed, or removed fitly. For example, in the case where the types of available telematics services vary depending on details of subscription, a field in which information indicating the types of telematics services available to the user is stored may be added to the subscription information table.

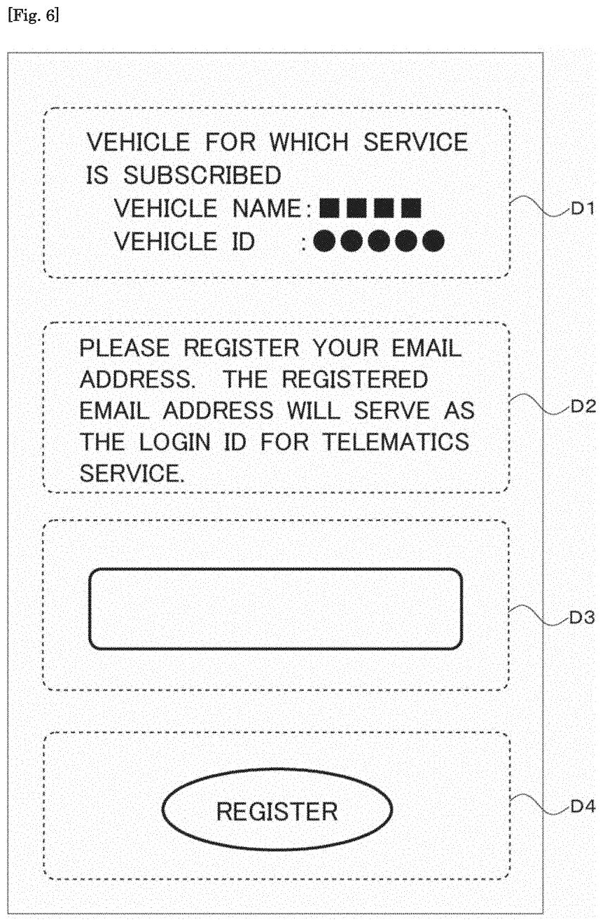

Referring back to FIG. 3, the setting part F210 constructs the aforementioned web server to interact with the user's terminal 300. For example, the setting part F210 causes the web browser of the user's terminal 300 to display a screen that allows the user to sign up to the telematics service (i.e. a screen that allows the user to make contract of subscription to the telematics service with the TSP). After contract of subscription to the telematics service is made between the user and the TSP, the setting part F210 causes the web browser of the user's terminal 300 to display a screen for setting the login ID. Specifically, immediately after the completion of assignment of the vehicle ID to the vehicle 10 of which the user has the ownership or the right to use, the setting part F210 causes the web browser of the user's terminal 300 to display a screen for setting the login ID. For example, as illustrated in FIG. 6, the screen for setting the login ID includes a field presenting information about the vehicle for which the telematics service is subscribed (D1 in FIG. 6), a field giving a message that prompts entry of an email address (D2 in FIG. 6), a field into which an email address is to be entered (D3 in FIG. 6), and a register button for completing registration of the email address (D4 in FIG. 6).

When the register button is operated with the email address entered in the field D3 in the screen illustrated in FIG. 6, the setting part F210 creates a subscription information table based on the email address entered in the screen illustrated in FIG. 6 and the vehicle ID determined by the TSP. Specifically, the setting part F210 creates a subscription information table in which the email address entered in the screen illustrated in FIG. 6 is stored in the login ID field and the vehicle ID determined by the TSP is stored in the vehicle ID field. The setting part F210 stores the subscription information table thus created in the subscription management database D210.

In the case where the user owns or has the right to use a plurality of vehicles including the vehicle 10 and has already set the login ID for the vehicles other than the vehicle 10, the setting part F210 may link the login ID that has already been set with the vehicle IDs of the plurality of vehicles.

The authentication part F220 performs authentication in response to an authentication request sent from the telematics terminal 100 or the user's terminal 300. Specifically, for example, the authentication part F220 accesses the subscription management database D210 using the login ID contained in the authentication request as an argument to determine whether a subscription information table in which a login ID identical to the login ID contained in the authentication request is stored in its login ID field is present in the subscription management database D210. If a subscription information table in which a login ID identical to the login ID contained in the authentication request is stored in its login ID field is present in the subscription management database D210, the authentication part F220 determines that the authentication is successful. If a subscription information table in which a login ID identical to the login ID contained in the authentication request is stored in its login ID field is not present in the subscription management database D210, the authentication part F220 determines that the authentication is failed. The result of the authentication by the authentication part F220 is sent to the telematics terminal 100 or the user's terminal 300 through the communication unit 204.

### Process Performed by Server Apparatus

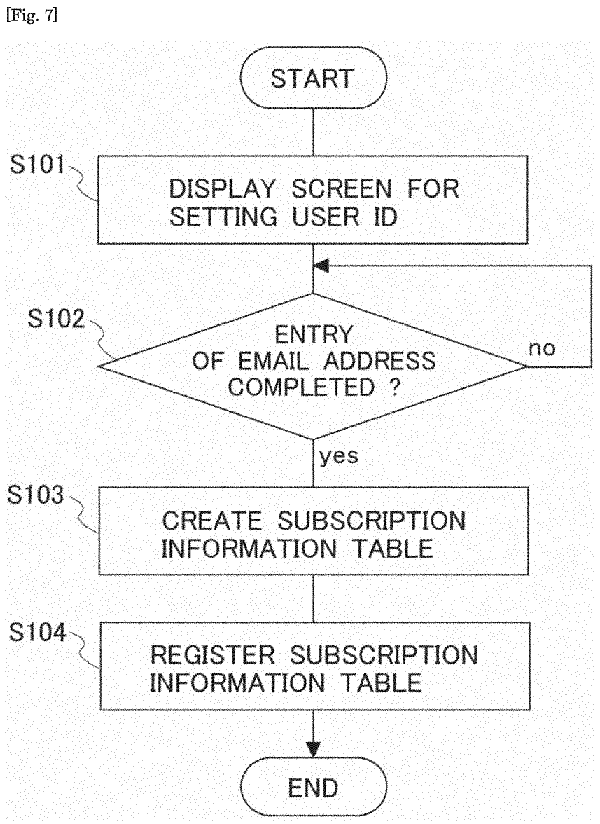

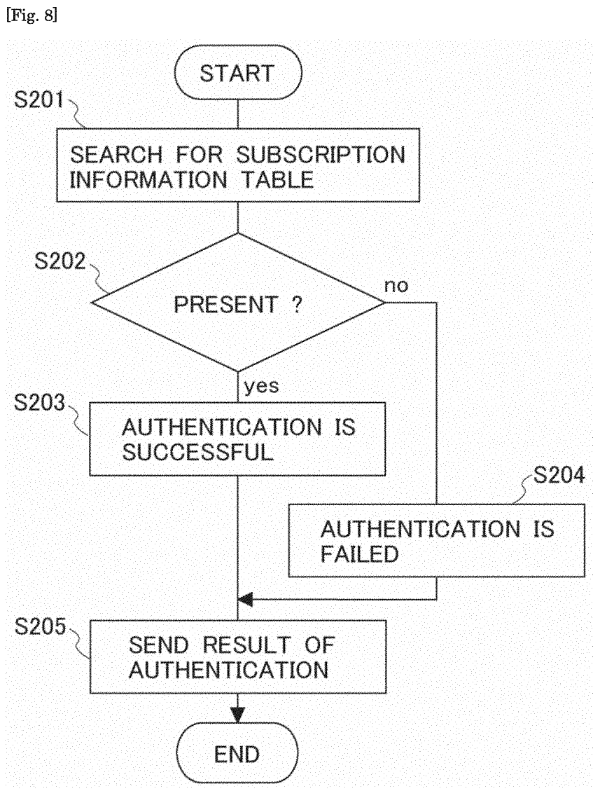

A process performed by the server apparatus 200 according to the embodiment will now be described with reference to FIGS. 7 and 8. FIG. 7 is a flow chart of a process executed by the server apparatus 200 when contract of subscription to the telematics service is made between the user and the TSP through the web server. FIG. 8 is a flow chart of a process executed by the server apparatus 200 when an authentication request is received from the telematics terminal 100 or the user's terminal 300. While the processing according to the flow charts of FIGS. 7 and 8 is executed by the processor 201 of the server apparatus 200, functional components thereof will be mentioned in the following description as components that executes various processing.

Referring firstly to the flow chart of FIG. 7, in step S101, the setting part F210 of the server apparatus 200 displays the screen for setting the login ID through the web browser of the user's terminal 300. As illustrated in FIG. 6, the screen for setting the login ID is a screen including a field showing information about the vehicle for which the telematics service is subscribed (D1 in FIG. 6), a field giving a message that prompts entry of an email address (D2 in FIG. 6), a field into which an email address is to be entered (D3 in FIG. 6), and a register button for completing registration of the email address (D4 in FIG. 6). After executing the processing of step S101, the setting part F210 executes the processing of step S102 next.

In step S102, the setting part F210 determines whether entry of an email address on the screen for setting the login ID has been completed. Specifically, for example, if an email address has not been entered in the email address field and/or the register button has not been operated on the screen illustrated in FIG. 6, the setting part F210 determines that entry of an email address has not been completed (a negative answer in step S102). Then, the setting part F210 waits until the completion of entry of an email address. If the register button has been operated with an email address entered in the email address field on the screen illustrated in FIG. 6, the setting part F210 determines that entry of an email address has been completed (an affirmative answer in step S102). Then, the setting part F210 executes the processing of step S103 next.

In step S103, the setting part F210 creates a subscription information table. Specifically, the setting part F210 creates a subscription information table in which the email address entered on the screen for setting the login ID is stored in the login ID field and the vehicle ID determined by the TSP is stored in the vehicle ID field. After executing the processing of step S103, the setting part F210 executes the processing of step S104 next.

In step S104, the setting part F210 stores the subscription information table created in step S103 in the subscription management database D210.

Next, a process executed by the server apparatus 200 when it receives an authentication request from the telematics terminal 100 or the user's terminal 300 will be described.

When the communication unit 204 of the server apparatus 200 receives an authentication request, the authentication part F220 of the server apparatus 200 accesses the subscription management database D210 using the login ID contained in the authentication request as an argument to search for a subscription information table in which a login ID identical to the login ID contained in the authentication request is stored in the login ID field (step S201). After the completion of the processing of step S201, the authentication part F220 executes the processing of step S202 next.

In step S202, the authentication part F220 determines whether a subscription information table that meets the above condition (i.e. a subscription information table in which a login ID identical to the login ID contained in the authentication request is stored in the login ID field) is present in the subscription management database D210. If a subscription information table that meets the above condition is present in the subscription management database D210 (an affirmative answer in step S202), the authentication part F220 determines that the authentication is successful (step S203). If a subscription information table that meets the above condition is not present in the subscription management database D210 (a negative answer in step S202), the authentication part F220 determines that the authentication is failed (step S204). After the completion of processing of step S203 or S204, it executes the processing of step S205 next.

In step S205, the authentication part F220 sends information indicating the result of the determination in step S203 or S204 (i.e. the result of the authentication) to the telematics terminal 100 or the user's terminal 300 from which the authentication request was sent.

In the case where information indicating success of the authentication is sent from the server apparatus 200 to the telematics terminal 100 or the user's terminal 300, login to the telematics service with the login ID is allowed on the telematics terminal 100 or the user's terminal 300, and a menu screen for available telematics services is displayed on it. If the user selects a telematics service that he or she wants on the menu screen, the telematics terminal 100 or the user's terminal 300 accepts use of the selected telematics service. Specifically, the telematics terminal 100 or the user's terminal 300 executes the processing for providing the selected service to the user. Thus, the user can enjoy the telematics service for the vehicle 10.

The system of this embodiment allows the user to log in to the telematics service with the login ID and use the telematics service for the vehicle 10. The login ID used in the system of this embodiment is a character string representing an email address of the user, and therefore it is easy for the user to remember the login ID when he or she uses the telematics service. In consequence, the user can use the telematics service for the vehicle 10 easily. In the case where the user owns or has the right to use of a plurality of vehicles, user can use the telematics services for the plurality vehicles with one login ID. This eliminates the need for the user to memorize login IDs as many as the vehicles.

As above, the telematics system of this embodiment can promote use of the telematics services by users.

### <First Modification>

Described in the above description of the embodiment is a case where the login ID is set at the time when contract of subscription to the telematics service is made between the user and the TSP. Described in the following as a modification is a case where the login ID is set after contract of subscription to the telematics service is made.

There may be cases where the user does not set the login ID at the time when contract of subscription to the telematics service is made. In such cases, it is desired that the user is given an opportunity to set the login ID after contract of subscription to the telematics service is made.

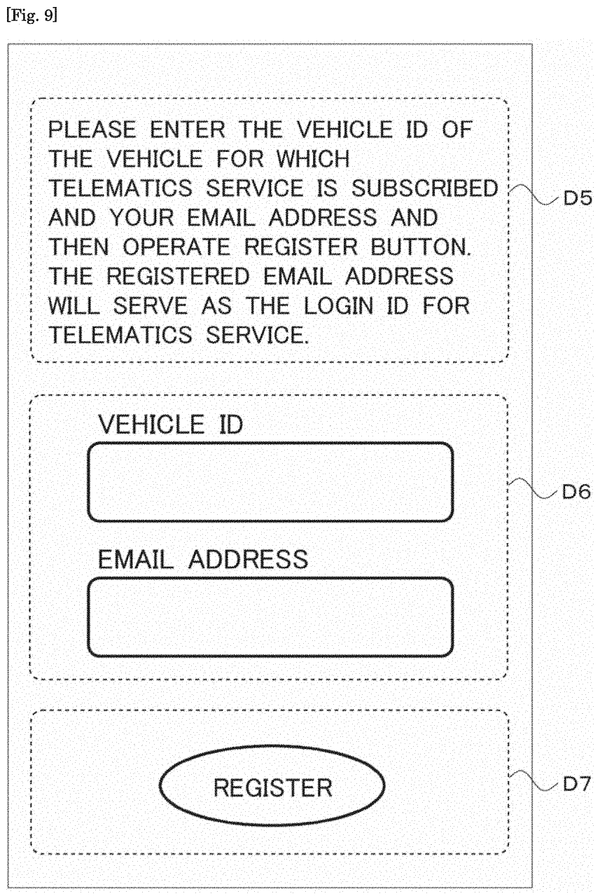

The setting part F210 of the server apparatus 200 in the telematics system of this modification is configured to cause the web browser of the user's terminal 300 to display a screen for setting the login ID when the user's terminal 300 accesses the web server through the web browser. For example, as illustrated in FIG. 9, the screen for setting the login ID may include a field giving a message that prompts entry of the vehicle ID and an email address (D5 in FIG. 9), a field into which the vehicle ID and an email address is to be entered (D6 in FIG. 9), and a register button for completing registration of the email address (D7 in FIG. 9).

When the register button is operated with the vehicle ID of the vehicle 10 and the user's email address entered in the screen illustrated in FIG. 9, the setting part F210 determines whether there is a vehicle associated with the vehicle ID entered in the screen illustrated in FIG. 9 among the vehicles for which the telematics service is subscribed. If there is a vehicle associated with the vehicle ID entered in the screen illustrated in FIG. 9 among the vehicles for which the telematics service is subscribed, the setting part F210 creates a subscription information table based on the email address and the vehicle ID entered in the screen illustrated in FIG. 9.

The setting part F210 may be configured to cause the telematics terminal 100 of the vehicle 10 associated with the vehicle ID to display a security code and cause the web browser of the user's terminal 300 to display a screen for entering the security code before creating the subscription information table. In this case, the setting part F220 may be configured to create the subscription information table on condition that a character string identical to the security code displayed on the telematics terminal 100 is entered on the aforementioned screen for entry. This will prevent the login ID from being set for a vehicle other than the vehicle 10 of which the user has ownership or the right to use, even if, for example, the user enters a wrong vehicle ID.

The setting part F210 may be configured to cause the web browser of the user's terminal 300 to display a screen for entering the vehicle identification number before creating the subscription information table. In this case, the setting part F210 may be configured to create the subscription information table on condition that a character string identical to the vehicle identification number of the vehicle 10 associated with the vehicle ID is entered on the aforementioned screen for entry. This also will prevent the login ID from being set for a vehicle other than the vehicle 10 of which the user has ownership or the right to use, even if, for example, the user enters a wrong vehicle ID.

The telematics system of this modification can give to the user an opportunity to set the login ID afterward in the case where the user does not set the login ID at the time of making contract of subscription to the telematics service.

### <Second Modification>

As described in the description of the first modification, in the case where the login ID is not set at the time when the contract of subscription to the telematics service is made, the setting part F210 of the server apparatus 200 may cause the telematics terminal 100 to display a screen that prompts the user to set the login ID at a later time. For example, the setting part F210 may send a command to the telematics terminal 100 to cause it to display a screen that prompts the user to set the login ID at the time when the vehicle 10 is started or when an operation relating to use of the telematics service is conducted on the telematics terminal 100. Consequently, the screen that prompts the user to set the login ID is displayed on the input and output unit 104 of the telematics terminal 100 every time the vehicle 10 is started or every time an operation relating to use of the telematics service is conducted. Thus, the telematics system can prompt the user who did not set the login ID when making contract of subscription of the telematics service to set the login ID.

### <Third Modification>

Some users who intend to use the telematics service may not want to set the login ID. In view of this, the telematics system may enable the user to log in to the telematics service with the vehicle ID instead of the login ID. For example, the telematics terminal 100 or the user's terminal 300 may display a login screen that prompts the user to enter the vehicle ID. When a login operation with the vehicle ID is conducted, the telematics terminal 100 or the user's terminal 300 may send an authentication request containing the vehicle ID to the server apparatus 200. The authentication part F220 of the server apparatus 200 may determine whether there is a vehicle 10 associated with the vehicle ID contained in the authentication request among the vehicles for which the telematics service is subscribed. If there is a vehicle 10 associated with the vehicle ID contained in the authentication request among the vehicles for which the telematics service is subscribed, the authentication part F220 may determine that the authentication is successful. Then, the server apparatus 200 may send information indicating the success of authentication to the telematics terminal 100 or the user's terminal 300. When receiving the information indicating the success of authentication from the server apparatus 200, the telematics terminal 100 or the user's terminal 300 may display a menu screen of telematics services.

The telematics system of this modification can allow users who do not set the login ID to use the telematics service.

### <Others>

The above embodiment and modifications have been described only by way of example. Changes and modifications can be made to them without departing from the essence of this disclosure. Processing and features that have been described in the above description of the embodiment and the modifications may be employed in any combination so long as it is technically feasible to do so. One, some, or all of the processes that have been described as processes performed by one apparatus may be performed by a plurality of apparatuses in a distributed manner. For example, the processing executed by the server apparatus 200 may be executed partly by the telematics terminal 100 or the user's terminal 300. The processing executed by the server apparatus 200 may be executed entirely by the telematics terminal 100 or the user's terminal 300. The hardware configuration employed to implement various functions in a computer system may be modified flexibly.

The technology disclosed herein can be carried out by supplying a computer program(s) (i.e. information processing program) that implements the functions described in the above description of the embodiment or the modifications to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of such a non-transitory, computer-readable recording medium include any type of discs including magnetic discs, such as a floppy disc (registered trademark) and a hard disk drive (HDD), and optical discs, such as a CD-ROM, a DVD, and a Blu-ray disc. The computer-readable, non-transitory storage medium may include other storage media, such as a ROM, a RAM, an EPROM, an EEPROM, a magnetic card, a flash memory, an optical card, and a solid state drive (SSD).

What is claimed is:

1. An information processing apparatus comprising a controller including at least one processor, the controller being configured to execute the processing of:
setting a first character string determined by a first user as a login ID for a telematics service; and
storing the login ID in a memory with its link with a first vehicle.

2. The information processing apparatus according to claim 1, wherein the first character string is a character string representing an email address of the first user.

3. The information processing apparatus according to claim 1, wherein the first character string is a character string representing a telephone number of the first user.

4. The information processing apparatus according to claim 1, wherein the first vehicle is a vehicle of which the user has the ownership or the right to use.

5. The information processing apparatus according to claim 4, wherein if there are a plurality of first vehicles, the controller links the login ID with the plurality of first vehicles.

6. The information processing apparatus according to claim 1, wherein the controller further executes the processing of:
causing a first terminal used by the first user to display a screen prompting entry of the first character string and a vehicle ID of the first vehicle; and
receiving the first character string and the vehicle ID entered into the first terminal from the first terminal.
wherein the controller sets the first character string received from the first terminal as the login ID and links the login ID thus set with the first vehicle associated with the vehicle ID.

7. The information processing apparatus according to claim 1, wherein if the login ID is not set, the controller causes a telematics terminal provided in the first vehicle to display a screen prompting setting of the login ID at a specific time.

8. The information processing apparatus according to claim 1, wherein if the login ID is not set, the controller executes the processing of:
receiving a vehicle ID of the first vehicle from a telematics terminal provided in the first vehicle;
performing authentication based on the vehicle ID received from the telematics terminal; and
if the authentication succeeds, allowing login to the telematics service.

9. An information processing method comprising the following steps of processing executed by a computer:
setting a first character string determined by a first user as a login ID for a telematics service; and
storing the login ID in a memory with its link with a first vehicle.

10. The information processing method according to claim 9, wherein the first character string is a character string representing an email address of the first user.

11. The information processing method according to claim 9, wherein the first character string is a character string representing a telephone number of the first user.

12. The information processing method according to claim 9, wherein the first vehicle is a vehicle of which the user has the ownership or the right to use.

13. The information processing method according to claim 12, wherein if there are a plurality of first vehicles, the computer links the login ID with the plurality of first vehicles.

14. The information processing method according to claim 9, wherein the computer further executes the steps of:
causing a first terminal used by the first user to display a screen prompting entry of the first character string and a vehicle ID of the first vehicle; and
receiving the first character string and the vehicle ID entered into the first terminal from the first terminal.
wherein the computer sets the first character string received from the first terminal as the login ID and links the login ID thus set with the first vehicle associated with the vehicle ID.

15. The information processing method according to claim 9, wherein if the login ID is not set, the computer causes a telematics terminal provided in the first vehicle to display a screen prompting setting of the login ID at a specific time.

16. The information processing method according to claim 9, wherein if the login ID is not set, the computer executes the steps of:
receiving a vehicle ID of the first vehicle from a telematics terminal provided in the first vehicle;
performing authentication based on the vehicle ID received from the telematics terminal; and
if the authentication succeeds, allowing login to the telematics service.

17. A non-transitory storage medium storing an information processing program configured to cause a computer to execute the following steps of processing:
setting a first character string determined by a first user as a login ID for a telematics service; and
storing the login ID in a memory with its link with a first vehicle.

18. The non-transitory storage medium according to claim 17, wherein the first character string is a character string representing an email address of the first user.

19. The non-transitory storage medium according to claim 17, wherein the first character string is a character string representing a telephone number of the first user.

20. The non-transitory storage medium according to claim 17, wherein the first vehicle is a vehicle of which the user has the ownership or the right to use.
